(19) United States
(12) Patent Application Publication
(10) Pub. No.: US 2008/0042624 A1
(43) Pub. Date: Feb. 21, 2008

(54) Circuit Arrangement and Method for Charging and Discharging at Least One Capacitive Load

(75) Inventors: Christian Augesky, Regensburg (DE); Martin Gotzenberger, Ingolstadt (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT

(21) Appl. No.: 11/632,109

(22) PCT Filed: May 11, 2005
(86) PCT No.: PCT/EP05/52138

§ 371 Date: Jan. 10, 2007

(30) Foreign Application Priority Data
Sep. 23, 2004 (DE) 10 2004 046 192.9

(51) Int. Cl. H02J 7/00

(52) U.S. Cl. 320/166

(57) ABSTRACT

High efficiency and low losses may be achieved in a circuit arrangement, for charging and discharging at least one capacitive load, in particular, a piezoactuator. The charging and discharging is achieved by way of ring-around processes in a resonant circuit, brought about by controlled opening and closing of at least one first switch and at least one second switch. A controller is provided to control the switches, based on at least one measured signal that is supplied to the controller. A capacitance and the switches are arranged such that the voltage drop across the capacitance is representative of the voltage drop across at least one of the switches. The capacitance has a current measuring resistance wired in series and the controller is provided with the voltage drop across the measuring resistance as measured signal.

The present invention relates to a circuit arrangement for charging and discharging at least one capacitive load, especially a piezoactuator of a fuel injector of an internal combustion engine.

The use of piezoelectric ceramic for actuating fuel injection valves of an internal combustion engine imposes considerable demands on the electronics for charging and discharging the piezoceramic. Comparatively large voltages (typically 100V or more) and briefly comparatively large currents for charging and discharging (typically more than 10 A) must be provided. To optimize the characteristics of the engine (e.g. exhaust gas figures, power, fuel consumption etc.) these charging and discharging processes should be undertaken within fractions of milliseconds with simultaneous extensive control of current and voltage. The attribute of the piezoceramic as an almost pure capacitive load with only comparatively low converted active power but on the other hand high reactive power demands more or less expensive circuit concepts for the electronics to control the piezo elements.

A circuit arrangement for controlling at least one capacitive control element is known from DE 199 44 733 A1. This known arrangement is based on a bidirectionally operated blocking converter and enables an exact allocation of energy portions during charging and discharging of the control element, so that almost any standardized current waveforms can be implemented on charging and discharging. The timing behavior is also fully controlled by a constant grid which underlies the individual switching processes. However the blocking converter principle on the other hand imposes not-insignificant strains on the switching transistors used, which can tend to have negative effects on the electrical efficiency and the associated thermal loading of the circuit arrangement. This has to be taken into account when selecting the electrical components to be used for the circuit arrangement. Even if this known solution is functionally entirely satisfactory, it has a certain potential for improvement as regards costs, electrical power dissipation and also electromagnetic compatibility, which could be of interest for future applications.

A circuit arrangement for charging and discharging a piezoelectric element is known from DE 198 14 594 A1. This known control circuit is based on a half-bridge final stage which controls the piezoelement via an inductance (choke), with the primary use of this choke being to limit the charging current occurring during charging and the discharging current occurring during discharging. Even if the charging can be undertaken with an uninterrupted current flow and thus with very high efficiency with this control and the stresses on the components used are lower than with the previously-mentioned blocking converter arrangement, this control needs a supply voltage, which must be more than the maximum voltage at the piezo valve. A DC/DC converter thus required in practice for example to convert a usual on-board motor vehicle voltage of 12V or 24V into a suitable supply voltage (e.g. several 100V), has a significant detrimental effect of the overall electrical efficiency of the control electronics.

The object of the present invention is to make it possible to charge and discharge at least one capacitive load highly efficiently and with low losses.

This object is achieved by a circuit arrangement as claimed in claim 1 and a method as claimed in claim 11. The independent claims relate to advantageous developments of the invention.

In the invention the charging and discharging is undertaken by ring-around processes in a resonant circuit arrangement so that advantageously the energy stored in the load during charging can be more less completely stored back during discharging and is thus available for a new charging process. The resonant circuit arrangement in this case includes the capacitive load to be charged and discharged as well as at least one inductance (e.g. choke coil) and at least one capacitance. The latter capacitance can in this case serve as a storage capacitance or for temporary storage of the energy within the resonant circuit arrangement. The ring-around processes are energized in this case by controlled closing and opening of a least one first switch and at least one second switch.

Preferably a number of ring-around processes are provided in each case for charging and discharging the capacitive load in order to transfer the electrical charge to be transferred into the load and back from the load in a number of stages, i.e. via a number of suitably embodied resonant circuit sections for the ring-around of energy and/or in individual “charging portions”.

In accordance with the invention there is also provision for effecting the feeding of energy from a supply voltage source into the resonant circuit arrangement by closing one of the switches. Through this measure the energy required for charging can be taken from the supply voltage source and electrical losses occurring in the area of the circuit arrangement can be compensated for.

The switches controlled in accordance with the invention by a control unit can for example be embodied as semiconductor switch elements, especially field effect transistors. This activation is undertaken based on at least one measurement signal entered into the control unit.

It is known that considerable switchover losses arise when switching over real switch elements if the switchover is undertaken “under load” such as when, immediately before the closing of the switch, a high voltage drops across the switch or immediately before the opening of the switch a high current is conducted via the switch. Accordingly it is advantageous for the switching to be undertaken at “zero voltage” or “zero current”.

In accordance with the invention the control unit is provided with a measurement signal which allows it in an especially simple and reliable manner to detect points in time in the ring-around processes at which the switches can be actuated with low switching losses. In accordance with the invention the voltage dropping at a current measurement resistance is used as the measurement signal, with this current measurement resistance (“shunt”) being switched in series with the capacitance and with this capacitance and the switches being arranged such that the voltage dropping across the capacitance is representative of the voltage dropping across at least one of the switches.

Through this specific way of providing the measurement signal used for controlling the switches the control unit is especially able to reliably detect those points in time in the ring-around processes at which at least the voltage dropping across one of the switches reaches an extreme value. Such an extreme value can for example be a minimum voltage (not absolutely necessarily 0 volts), with the switch concerned, on reaching this minimum, being able to be switched on without appreciable switching losses. If the point in time determined is the point at which the maximum of the voltage dropping across the switch is reached, this can advantageously be used to switch on another switch with low switching loss in the case in which the voltages dropping at the 2 switches are complementary because of the circuit configuration involved, in the sense that the voltage dropping at one switch becomes greater the smaller is the voltage dropping at the other switch at the same point in time. This type of complementary arrangement is produced for example for circuit concepts in which the first switch and the second switch form a series circuit to which an essentially fixed predetermined voltage is applied. This circuit concept is thus to be considered as one of the preferred forms of embodiment of the invention.

A particular advantage of the invention lies in the fact that, especially for extreme values of the voltage dropping at a switch which are only reached very gradually in terms of time, the time at which this extreme value is reached can be determined especially precisely. This is possible, because in accordance with the invention, it is not necessary to know the extreme value or to find out about it in advance and then include it as reference for a comparison with the actual dropping voltage. Instead it is possible in accordance with the invention to recognize the precise end time at which the extreme value is reached from the fact that the time of the voltage dropping at the switch concerned becomes approx. zero or has a zero crossing point. This principle allows the “correct switching times” which are of great significance for the reduction of switching losses, to be significantly more accurately determined. Since the voltage dropping across the capacitance is representative of the voltage dropping across the switch involved, that is especially for example identical with the dropping voltage, the current flowing into or out of the capacitance becomes minimal when reaching an extreme voltage (zero or zero crossing). However it is precisely this current that can be measured in a simple manner by the current measurement resistance arranged in a series circuit with the capacitance. The voltage dropping at the current measurement resistance is proportional to this current.

In a preferred embodiment there is provision for the resonant circuit arrangement to comprise a series circuit formed from the inductance and the capacitive load and for the charge current or discharge current to be routed via the inductance both when the capacitive load is charged and when it is discharged. Through this measure the inductance can be used not simply as a temporary energy store but also advantageously to limit the charging and discharging current. For example a connection of the inductance via an electrical path (with or without intermediate connection of an output filter) can be made to the capacitive load, whereas the other connection of the inductance by a further electrical path to a switching node can be made which forms a center tap of a series circuit of the two switches.

In a preferred embodiment the control unit features a comparator for comparing the measurement signal with at least one threshold value. Such a comparison makes it easy for the control unit to determine the optimum switching times. Because of the particular way in which the measurement signal is provided a threshold value of around 0 volts can be selected here which is advantageous as regards circuit design. An earlier solution for optimum switching times based on internal operational knowledge of the applicant uses a direct measurement of the voltage at a switching transistor. Because of the relatively high voltages in the range of the several hundred volts, especially in output stages for piezoactuators, this voltage initially had to be heavily divided however in order to obtain a suitable voltage level for a normal comparator. In addition to a comparatively high inaccuracy of determination was produced by gradually reaching an extreme value. These disadvantages are overcome with the present invention. If for example the peak value of a sinusoidal resonance is to be detected, simply the zero crossing of the measurement signal used in accordance with the invention (=temporal derivation of the voltage) is to be detected for this.

In a further development there is provision for the measurement signal to be compared during operation of the circuit arrangement with a number of threshold values, that is for a comparator to be used for example of which the reference corresponding to the threshold value is changed during the operation of the circuit arrangement.

The ability to change the threshold value in the operation of the circuit arrangement has the particular advantage of enabling in a simple manner the reaching of an extreme value of the voltage dropping at the current measurement resistor to be readily detected if this extreme value is present for a specific period of time as a result of the concept, meaning that “temporally-extended” maxima or minima are involved. The reaching of a maximum can then for example be detected with a small positive threshold value (corresponding to the small positive slope of the voltage curve immediately before the maximum is reached), whereas the reaching of a minimum can be detected by using a small negative threshold value (corresponding to the small negative slope on reaching the minimum). Since the rough timing of the ring-around processes is defined by the circuit concept used and the electrical characteristics of the components used, no difficulties arise in practice in converting the comparison threshold value “at the right time” (clocked) in each case to one of two predetermined threshold values (in order to detect alternately maxima and minima of the voltage drop across the capacitor or the switch).

So that the voltage dropping across the capacitance is representative of the voltage drop across the corresponding switch, provision can be made for example to arrange the capacitance in a path arranged in parallel to the relevant switch. This ensures that a higher voltage at the switch is conditional on a corresponding higher voltage at the capacitor. If the current measurement resistance is embodied as a shunt with a comparatively small electrical resistance and forms this parallel path in conjunction with the capacitance, the voltage dropping at the resistance can be ignored in relation to the voltage dropping at the capacitance. In this case the voltage dropping at the capacitance is practically the same as the voltage dropping at the switch.

There is provision in a development of the invention for a further capacitance to be connected in parallel to the series circuit comprising the capacitance and the current measurement resistance This subdivision of the capacitance onto two parallel paths has practically no role to play for the electrical characteristics of this section of the circuit, however in practical terms it has a major advantage with regard to the realization of the current measurement resistance. This is because the current measurement resistance should have the smallest possible resistance value for minimizing resistive losses, which as a rule leads to comparatively high costs. When the capacitance is subdivided into a number of parallel paths the current measurement resistance can tend to be implemented with a higher resistance value for a predetermined power loss, and thereby at lower cost. This advantage is especially great if the further capacitance is greater than the capacitance connected in series with the current measurement resistance, in particular for example is greater by a factor of more than 10. Especially with circuit arrangements for charging and discharging piezoactuators of a fuel injection engine it is generally necessary, for a precise measurement of the fuel injection amount, to assign to the piezoactuator a current measuring resistance in the series circuit in order to detect the charge current or discharge current on the basis of the voltage dropping there. The arrangement of this piezocurrent measurement resistance can be used within the framework of the present invention in a specific form of embodiment, in that the capacitance of the resonant circuit arrangement is arranged in series with this current measurement resistance which is provided in any event. The costs of a relatively expensive shunt resistor can thus be saved.

The invention will be described in greater detail below on the basis of exemplary embodiments with reference to the enclosed drawings. The Figures show:

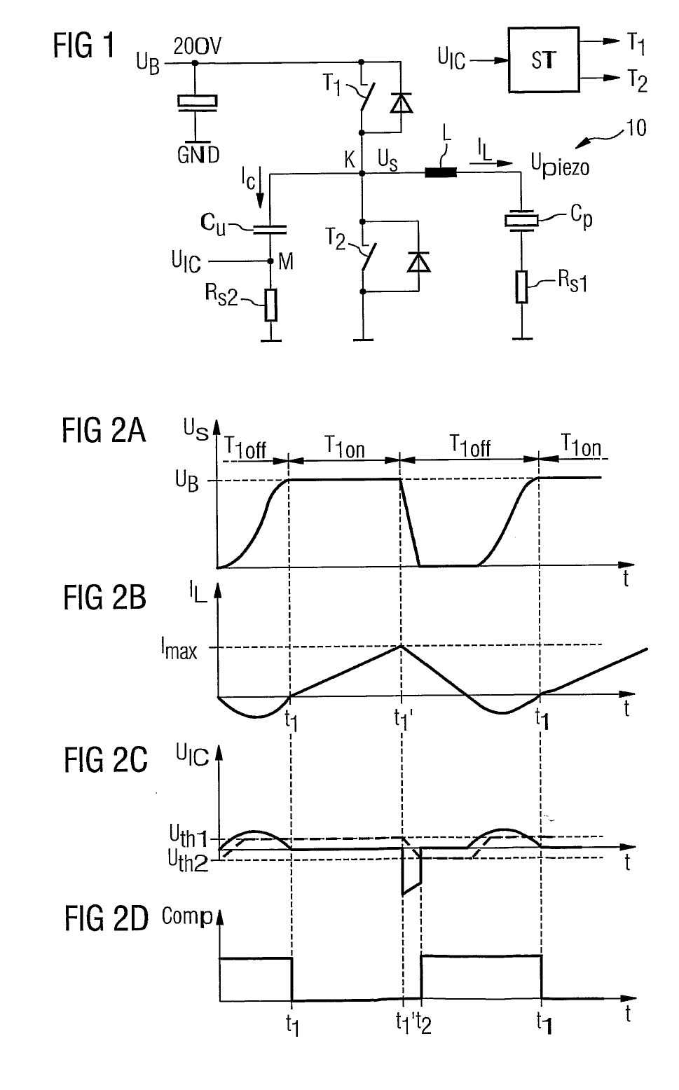

FIG. 1 is a block diagram of major components of an output stage to control at least one piezoactuator,

FIG. 2 is a diagram of a number of signal traces in the circuit arrangement shown in FIG. 1,

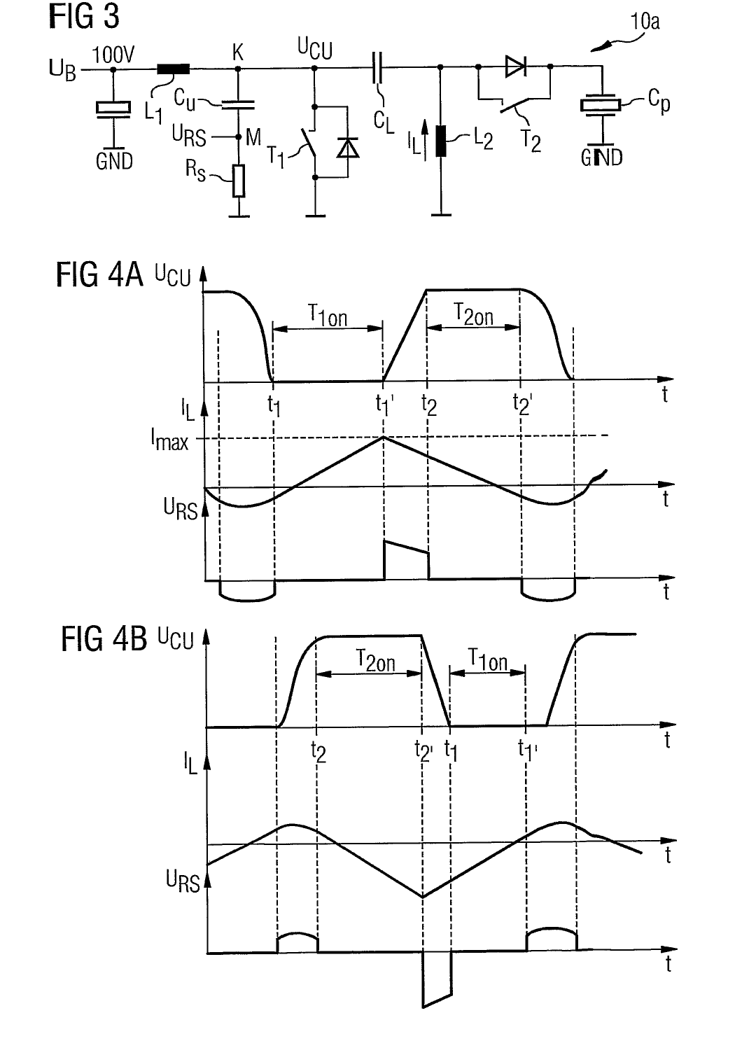

FIG. 3 depicts an output stage in accordance with a further embodiment,

FIG. 4a is a diagram of a number of signal traces in the circuit arrangement shown in FIG. 3,

FIG. 4b is a diagram of the signal traces in the circuit arrangement shown in FIG. 3 on discharging,

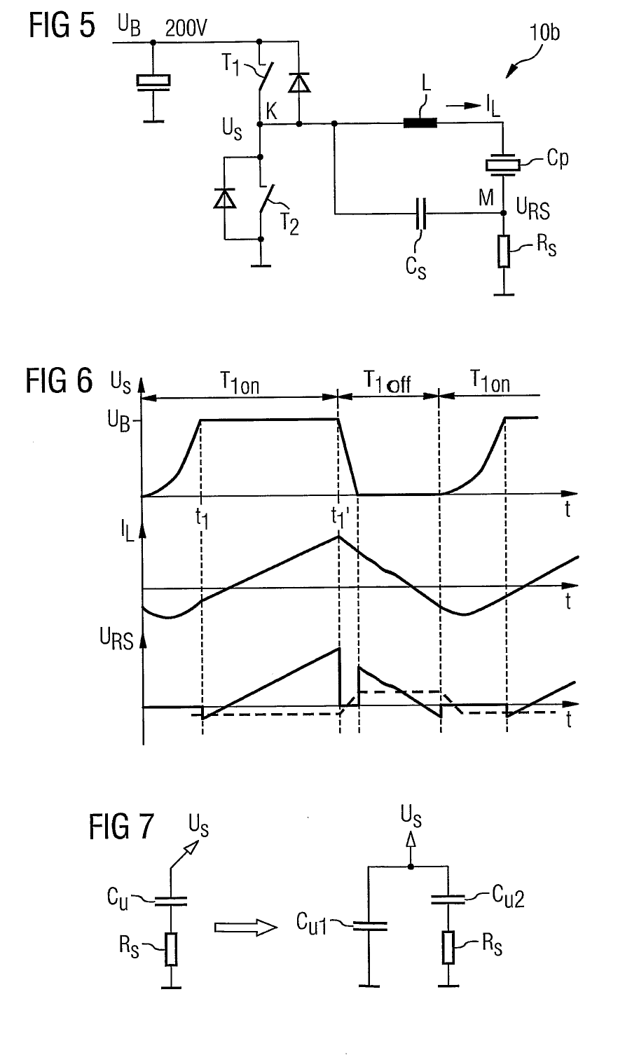

FIG. 5 depicts an output stage in accordance with a further embodiment,

FIG. 6 is a diagram of a number of signal traces in the circuit arrangement in accordance with FIG. 5, and

FIG. 7 is a diagram to illustrate the subdivision onto two parallel branches of a storage capacitance used in an output stage.

FIG. 1 shows an overall output stage identified by the number 10 for controlling a plurality of piezoactuators of a fuel injection system of a motor vehicle. To make the diagram simpler only one of the piezoactuators to be controlled by charging and discharging is shown; this being identified by the letters Cp. In a well-unknown manner a number of injectors can be controlled with an output stage or by what is known as a “bank” of an output stage, e.g. by arranging selection switches in the line connection between the output stage and the individual piezoactuators Cp.

The layout of the circuit arrangement according to FIG. 1. will first be described. The output stage 10 is supplied with a supply voltage U_{B} (e.g. 200 V) which is provided by the output of a DC/DC converter and is stabilized by a buffer capacitor as shown in FIG. 1.

This supply voltage U_{B} is applied between a first supply terminal and a second supply terminal (vehicle chassis GND) with a series circuit comprising two controllable switches being arranged between these supply terminals, said switches being formed in the example shown by field effect transistors T₁ and T₂. The diodes shown in the diagram in parallel to these switches T₁, T₂ in each case symbolize the substrate diodes of the FETs used. In a different design of these semiconductor circuit elements these diodes can be arranged separately.

A circuit node K can be seen as a center tap of this circuit arrangement from which on one side an electrical path via an inductor L leads to a first terminal (“high side”) of the piezoactuator Cp and on the other side an electrical path leads via a storage capacitor Cu and a series-connected current measurement resistor R_{S2} to ground GND. The series circuit comprising capacitor Cu and resistor R_{S2} is also arranged in parallel to the second switch T₂. A circuit node M shown as a center tap of this series circuit delivers a voltage signal U_{IC} which is fed as a measurement variable to a control unit ST. This control unit ST provides at its output control signals for the two switches T₁, T₂. In the present case these are corresponding gate potentials for the switches embodied as FETs.

The other connection of the piezo actuator Cp is routed via a further current measurement resistance R_{S1} to ground GND.

A current sensing signal tapped at the current sensing resistance R_{S1}, which is representative of the current flowing during charging and discharging of the piezoactuator Cp is fed to the control unit ST and is used within the framework of the regulated control. This is not however shown in the Figure since this current sensing or the regulation based on it is well known to the person skilled in the art and is not of any significance for the understanding of the present invention.

The functions of the output stage 10 will be explained below with reference to FIG. 1 and FIG. 2.

The capacitance Cu shown in FIG. 1, along with the charging inductance L forms a section of the resonant circuit, which is energized in the correct rhythm by closing and opening of the switches T₁, T₂.

FIG. 2 illustrates the timing sequence of a series of signals in the circuit arrangement in accordance with FIG. 1 when piezoactuator Cp is charged. These individual signals are the voltage U_{S} prevalent at the switching node K (FIG. 2a), the current flowing through the inductance (charge current or discharge current) I_{L} (FIG. 2b), the current sensing voltage U_{IC} tapped off at the current sensing resistor R_{S2} (switching node M) (FIG. 2c, thick line) and an output signal (FIG. 2d) comp of a comparator contained in the control unit ST, which compares the current measuring voltage U_{IC} with one of two threshold voltages Uₜₕ₁, Uₜₕ₂ (FIG. 2c, dashed lines). For reliable detection of the correct switching times there is a gradual rather than a sudden transition from a threshold voltage to another threshold voltage and vice versa (cf. FIG. 2c, thin line).

The charging and discharging of the piezoactuator Cp is undertaken by ring-around processes on a resonant circuit arrangement, which in the example shown is formed by the piezoactuator Cp itself, the inductance L and the storage capacitance Cu. When the piezoactuator is charged, a multiple clocked closing of the first switch T₁ causes an electrical charge to be rung around “in portions” via the inductance L into the piezoactuator Cp.

It is assumed that, at a point in time t1 (FIG. 2) the full supply voltage U_{B} drops via the storage capacitance Cu and at this point, the first switch T₁ which will subsequently be referred to below as the charging switch, is closed. The result is that, in a phase designated as T₁on, a rising linear current I_{L} flows through the inductance L (charge current). At a later time t1* the charge switch T₁ is switched off again, with the precise time in this case being predetermined for example by the control unit ST such that the switch-off occurs as soon as the charge current measured by means of the further current sensing resistance R_{S1} reaches a predetermined maximum value Iₘₐₓ.

In the subsequent period T₁off the current IL drops back, starting from this maximum value Iₘₐₓ again, with the current initially being provided by discharging of the storage capacitance Cu and then, if the capacitance Cu is fully discharged, this current being provided via the diode (free-wheeling diode) of the second switch T₂ opened during the entire charging process. At this moment the piezoactuator Cp is charged to some degree by a ringing around of the energy stored in the inductance L onto the capacitance of the piezoactuator Cp. The timing sequence is definitively determined by the characteristics of the “arrangement” (series circuit comprising inductance and capacitance of the piezoactuator), which forms a section of the overall resonant circuit arrangement.

Once the charge current I_{L} is in place at the end of the period T₁off, the leading sign of this current reverses, i.e. current flows through the inductance L back into the output stage, so that the voltage U_{S} increases at the circuit node K or the voltage drop-off across the capacitance Cu continues to increase. The energy which is transferred back in this phase is advantageously stored in the capacitance Cu and is available for the next ring-around process for further charging of the piezoactuator.

As soon as the voltage U_{S} dropping across the capacitance Cu has reached its maximum value again, the charging switch T₁ is closed again. The process described is thus repeated. To optimize the output stage as regards its efficiency, great importance is attached to the definition of the “correct switching time” t1, since otherwise significant losses occur. Electromagnetic disturbances can also be drastically reduced by suitable selection of this switching time t1.

The definition of the switch-on time t1 undertaken by the control unit ST is based in detecting that point in time at which the voltage U_{S} reaches its maximum value. To this end the voltage U_{IC} dropping off at the current-measuring resistance R_{S2} is routed to the control unit ST via the circuit node M. The control unit ST generates a switch-off signal as soon as this voltage U_{IC} falls below a defined (positive) threshold value Uₜₕ₁ approaching zero. Reaching a low threshold value in this way is synonymous with a voltage U_{S} which in practice changes very little per se, which, for its part, is characteristic of reaching the maximum value of U_{S}. The maximum value detection as an indicator for the completion of a ring-round process is thus highly-secure and easy to implement.

With synchronous switchover of the comparator threshold (from Uₜₕ₁ to Uₜₕ₂ and vice versa) a single comparator is sufficient for both switching points (t1 and t2) to be detected. This synchronous switchover is already taken into account in the diagram in accordance with FIG. 2d. The comparison result comp shown is produced using Uₜₕ₁ to define switching time t1 and using Uₜₕ₂ to determine switching time t2 (on discharging).

The advantages of the output stage are also evident for the case in which, because of the voltage at the piezoactuator, it is not possible to achieve a voltage drop at the switches T₁, T₂ of 0 V. The important thing is that the fashion in which the switching times are defined is based on the detection of minimum values or maximum values (of the voltage U_{S}).

The functional principle underlying the invention can in particular be applied to all quasi-resonant switching stages.

The piezoactuator Cp is discharged in the corresponding manner by multiple actuation of the second switch T₂, to be referred to as the discharging switch.

In a variation of the exemplary embodiment shown, the storage capacitance Cu could also be arranged in parallel to the charging switch T₁ for example.

The subsequent description of further exemplary embodiments essentially only deals with the differences between these and the previously described exemplary embodiments and thus expressly refers back to the description of previous exemplary embodiments.

FIG. 3 illustrates the functional principle of the detection of suitable switching times using another circuit topology as an example, which operates with a further storage capacitance C_{L} in a longitudinal branch and can be operated in an step-up conversion mode, in which one supply voltage UH (here: 100 V) is sufficient, which only corresponds to half of the maximum voltage (here 200V) to be applied to the piezoactuator Cp.

To make the diagram simpler, the control unit ST provided for the control of the two switches T₁ and T₂ is omitted from FIG. 3. FIGS. 4a and 4b show the signal traces produced both for a charging process (FIG. 4a) and also for a discharging process (FIG. 4b).

As a result of the step-up converter principle of the output stage 10a shown in FIG. 3, both during charging and discharging of the piezoactuator Cp, the two switches T₁, T₂ are closed alternately for specific periods of time, said periods being indicated in FIG. 4 by T₁on and T₂on.

The ring-around processes for charging and discharging are undertaken at a resonant circuit arrangement which is formed from a first inductance L1, a second inductance L2, a first storage capacitance Cu, the second storage capacitance C_{L} and also the piezoactuator Cp.

The circuit layout is as follows: The positive pole of the supply voltage U_{B} is fed via the first inductance L1 to a switching node K, from which a first path leads via a series circuit from the capacitance Cu and a current measuring resistance R_{S} to ground GND. At a center tap M of the series circuit a measuring signal (voltage U_{RS}) is again provided as an input variable for the control unit ST (not shown). The first switch T₁ along with its free-wheeling diode is connected in parallel with this series circuit. Furthermore a series circuit comprising the further capacitance C_{L} and the further inductance L2 runs in parallel with this switch T₁. A circuit node located between the latter components finally leads via the second switch T₂ including free-wheeling diode in the longitudinal branch on to the positive control connection of the piezoactuator Cp. A voltage measuring resistance (not shown) for measuring the charging and discharging current is arranged in a series circuit with this piezoactuator.

At a time t1 the capacitance C_{L} is fully charged and the switch T₁ will be closed. This causes capacitance C_{L} to discharge itself via the second inductance L₂. With this ring-around process energy is rung around from C_{L} to L₂. This causes the current flowing through L2 to increase and it only falls gradually after the opening of the switch T₁ at time t1′. The closing of the second switch T₂ at a time t2 then results in the current I_{L} for charging flowing into the piezoactuator Cp. A further ring-around process of energy then ensues, starting from L2 to Cp. Shortly after this charging current I_{L} has changed its leading sign, the second switch T₂ is switched off again (time t2′). The current continuing to flow in the opposite direction I_{L} continues to charge the further capacitance C_{L}. After a certain delay the ring-around processes described repeat themselves (clocked charging).

FIG. 4b depicts the corresponding timing curves during the (clocked) discharging of the previously charged piezoactuator Cp.

For the output stage 10a shown in FIG. 3 the optimum switching times for the switches T₁ and T₂ are determined, namely a determination of the times t1 and t2 during both charging and also discharging.

FIG. 5 shows a further output stage 10b, of which the topology has been selected to be similar to that of the circuit arrangement described in FIG. 1.

An important difference between this output stage and the output stage 10 described in accordance with FIG. 1 lies in the fact that the measurement resistance R_{S} arranged for measurement of the charging current or discharging current is used for the provision of the measuring signal mentioned for the control unit ST (not shown). For this purpose there is a storage capacitance Cs, connected together with the piezoactuator Cp on its “measuring side”, as can be seen in FIG. 5.

The resulting, somewhat more complex signal traces are shown in FIG. 6 using the charging process as an example.

Again advantageous optimum switching times for the switches T₁ and T₂ can be determined with reference to a comparison with a measurement voltage U_{RS} tapped off at a circuit node M. In the circuit example shown these are the times t1 for charging and t2 for discharging.

For the evaluation of the measuring signal U_{RS} the corresponding logic with built-in dead time zones can be used to form a correct selection from the comparator pulses. This is generally possible without any problems with integrated control circuits and in the final analysis saves on components and costs. Even the effective losses in the measurement resistance R_{S} can be reduced by this.

A further option of making savings in the costs of the relatively expensive shunt resistor is to divide up the storage capacitance into two capacitances arranged in parallel to each other, with one of them only supplying a fraction of total capacitance necessary for the ring-around principle. This division of the capacitance is illustrated in FIG. 7.

Instead of a simple series circuit comprising Cu and R_{S} (FIG. 7 left), a further capacitance Cu₁ can advantageously be inserted connected in parallel (FIG. 7 right) in the series circuit of a capacitance Cu₂ and a current measurement resistance R_{S} important for the output stages above. The requirements imposed on the power characteristics of the shunt resistor are thus reduced considerably, and it can then be embodied more simply as a chip resistor for example. Under some circumstances the layout of a circuit board can also be better optimized in this way, since this carries comparatively small currents over the current path carrying the current measuring resistance.

1-11. (canceled)

12. A circuit arrangement for charging and discharging at least one capacitive load (Cp), comprising:
a resonant circuit for charging and discharging the at least one capacitive load through ring-around processes, said resonant circuit including the capacitive load, at least one inductance, and at least one capacitance;
a first switch and a second switch for energizing the ring-around processes by controlled closing and opening thereof, said first and second switches being connected to enable feeding energy from a supply voltage source into said resonant circuit;
a control unit for controlling said first and second switches, said control unit having an input for receiving a measurement signal;
wherein said capacitance and said first and second switches are configured such that a voltage dropping across said capacitance is representative of the voltage dropping across at least one of said first and second switches;
a current measuring resistance connected in series with said capacitance, a voltage dropping at said current measuring resistance forming the measurement signal input into said control unit.

13. The circuit arrangement according to claim 12, wherein said capacitive load is a piezoactuator.

14. The circuit arrangement according to claim 12, wherein said capacitive load is a piezoactuator of a fuel injector of an internal combustion engine.

15. The circuit arrangement according to claim 12, wherein said resonant circuit comprises a series circuit formed from said inductance and the capacitive load, and wherein a charging current during charging the capacitive load and a discharging current during discharging of the capacitive load are routed via said inductance.

16. The circuit arrangement according to claim 12, which comprises an output of a direct current converter forming said supply voltage source.

17. The circuit arrangement according to claim 12, wherein said first and second switches are field effect transistors.

18. The circuit arrangement according to claim 12, wherein said control unit is configured to detect, from the measurement signal, times in the ring-around processes at which the voltage dropping across one of the switches reaches an extreme value.

19. The circuit arrangement according to claim 12, wherein said control unit (ST) includes a comparator for comparing the measurement signal with at least one threshold value.

20. The circuit arrangement according to claim 12, wherein said capacitor is connected in a path parallel to one of said first and second switches.

21. The circuit arrangement according to claim 12, which comprises a further capacitance connected in parallel with the series circuit formed by said capacitance and said current measuring resistance.

22. The circuit arrangement according to claim 21, wherein said further capacitance is greater than said capacitance connected in series downstream from said current measuring resistance.

23. The circuit arrangement according to claim 22, wherein said further capacitance is greater by a factor of more than 10.

24. A method of charging and discharging at least one capacitive load through ring-around processes on a resonant circuit formed from the capacitive load, at least one inductance, and at least one capacitance, the method which comprises:
energizing the ring-around processes by controlled closing and opening of at least one first switch and at least one second switch;
feeding energy into the resonant circuit from a supply voltage source by closing one of the first and second switches;
controlling the first and second switches with a control unit based on at least one measurement signal supplied to the control unit;
connecting the capacitance and the switches such that a voltage dropping across the capacitance is representative of the voltage dropping across at least one of the switches; and
measuring, with a current measuring resistance connected in series with the capacitance, a voltage drop at the current measuring resistance and supplying the voltage drop to the control unit as the measurement signal for controlling the first and second switches.
